(19) United States
(12) Patent Application Publication
(10) Pub. No.: US 2016/0029676 A1
(43) Pub. Date: Feb. 4, 2016

(54) Sodium Contrast for Reducing Sodium Content

(71) Applicant: Frito-Lay North America, Inc., Plano, TX (US)

(72) Inventors: Juan Ignacio Corujo-Martinez, Frisco, TX (US); James Williams Stalder, Dallas, TX (US); Alexa W. Williams, McKinney, TX (US)

(21) Appl. No.: 14/445,842

(22) Filed: Jul. 29, 2014

(51) Int. Cl. A23L 1/237; A23P 1/08

(52) U.S. Cl. CPC A23L 1/237; A23P 1/082; A23V 2002/00

(57) ABSTRACT

The invention allows for the production of a savory food product with reduced sodium content. The savory food product is formed from a mixture of cooked food pieces selected from a first portion and a second portion at a predetermined application ratio. The first portion of food pieces is salted a first salt intensity and the second portion of food pieces is salted at a second salt intensity. Preferably, the first and the second salt intensities have an application amplitude of at least 20% so that sodium content can be reduced without sacrificing the perceived saltiness of the savory food product.

### BACKGROUND OF THE INVENTION

1. Technical Field

The present invention is directed generally to a product and corresponding method and system for creating a savory food product having reduced sodium content. More particularly, the present invention is directed to sodium reduction by implementing sodium contrast in a savory food product formed from a plurality of food pieces.

2. Description of Related Art

Although salt is a popular and effective seasoning, in recent years, some consumers have expressed a preference for food products having reduced levels of sodium. To address these changing preferences, snack food manufacturers have applied a number of different methods for reducing sodium content. For example, snack food recipes have been modified to use less salt, product flavors have been altered or rebalanced to mask the effect of other ingredients, salt crystal sizes have been modified to alter the perceived saltiness of salt crystals, and salt substitutes have been used. However, these currently used methods suffer from various drawbacks, including but not limited to increased cost or complexity, and negative consumer perceptions. Thus, a need still exists in the art for a way of reducing the sodium content of savory food products without reducing its perceived saltiness or otherwise diminishing consumer perception of the product.

### SUMMARY OF THE INVENTION

The present invention is directed to a savory food product and a corresponding system and method. More particularly, this invention further provides for a savory food product that is formed from a plurality of food pieces. In addition, the invention discloses a system and method for utilizing sodium contrast to achieve sodium reduction without negatively affecting perceived saltiness. Non-limiting examples of the savory food product can include potato chips, pretzels, nuts, seeds, and tortilla chips. Additionally, savory food products may also include items that are both sweet and savory, such as sea salted caramels.

Sodium contrast is a method of increasing the perceived saltiness of a savory food product by taking advantage of the fact that sensory receptors are more sensitive to stimulus contrasts, as already confirmed by the results of research performed to date (Buscha et al., 2013). To this end, Applicants have designed and executed experiments to confirm the viability of using sodium contrast on a savory food product formed from a plurality of food pieces. The experiments tested the effect of certain variables on the perception of saltiness, including application amplitudes, application ratios, and average salt concentration and compared those results with control samples having a specific salt intensity.

As used herein, the term “salt intensity” describes the sodium concentration of a sample of a savory food product wherein every food piece in the sample is uniformly treated, resulting pieces having substantially the same, uniform salt concentration. Furthermore, the word “uniform” allows for some differences or variances due to typical uncertainties inherent in manufacturing tolerances. Thus, a sample with a salt intensity of 0.90 weight percent is formed from one or more pieces, each of which is uniformly salted at 0.90 weight percent according to any currently existing or later developed methods and/or systems. Salt intensity may also relate to an “average salt concentration.” For example, the sample with a salt intensity of 0.90 weight percent also has an average salt concentration of 0.90 weight percent because every food piece in the sample has the same salt intensity. However, when a savory food product sample is formed from two portions having different salt intensities, the average salt concentration is calculated with respect to the salt intensity of each portion and the relative amounts of each portion that is combined to create the savory food product.

“Average salt concentration” can be approximated with reference to the number of food pieces selected from each of the two differently salted portions, or determined with reference to the weight of food items selected from each portion. Accordingly, a sample of a savory food product formed from a plurality of pieces having a salt intensity of 0.90 weight percent also has an average salt concentration of 0.90 weight percent. However, a sample of a savory food product formed from two separate portions having different salt intensities will have an average salt concentration that differs from the salt intensities of each of the two portions. For example, a sample of a savory food product formed from a first portion with a salt intensity of 0.60 weight percent, and a second portion with a salt intensity of 1.20 weight percent will have an average salt concentration of 0.90 weight percent if the two samples are combined in a 1:1 ratio. The ratio may be determined on a piecewise or weight basis.

“Application amplitude” is a variable describing the relationship between a salt intensity of two differently salted portions, and the average salt concentration of a savory food product formed from a plurality of food pieces selected from the differently salted portions. Thus, in the example described above where a savory food product was formed from a first portion having a salt intensity of 0.60 weight percent, a second portion having a salt intensity of 1.20 weight percent, and an average salt concentration of 0.90 weight percent, the application amplitude is 0.30 weight percent. Restated, in an illustrative embodiment with an average salt concentration of 0.90 weight percent and an application amplitude of 0.30, a first portion of the savory snack pieces would have a salt intensity of about 0.60 weight percent and a second portion would have a salt intensity of about 1.2 weight percent sodium. As used herein, application amplitude may also be described in terms of percentages of the average salt concentration. Thus, the example above can also be described as having an application amplitude of about 33% since the application amplitude of 0.30 weight percent is one-third of the average salt concentration, 0.90 weight percent.

Additionally, the application amplitude of a sample may also be described as an upper application amplitude and a lower application amplitude in the event that the magnitudes of the two application amplitudes differ. For example, a sample having an average salt concentration of 1.0 weight percent, but formed from a first portion having a salt intensity of 1.1 weight percent and a second portion having a salt intensity of 0.8 weight percent, the sample can be described as having an upper application amplitude of 0.10 weight percent and a lower application amplitude of 0.20 weight percent.

“Application range” describes a magnitude of the difference of the upper application amplitude and the lower application amplitude. Thus, in a sample having an application amplitude of 0.30 weight percent will have an application range of 0.60 weight percent. Similarly, a sample having an average salt concentration of 1.0 weight percent, but formed from a first portion having a salt intensity of 1.1 weight percent and a second portion having a salt intensity of 0.8 weight percent, the sample will have an application range of 0.3 weight percent.

An “application ratio” is a variable that relates to the relative amounts food pieces selected from each of the two differently salted portions that are combined to form the savory food product. For example, if a sample of a savory snack food is formed from equal amounts of a first portion and a second portion, then the application ratio is 1:1. Likewise, if twice as many food pieces are selected from the first portion than the second portion, then the savory snack food has an application ratio of 2:1. Additionally, the application ratio may also be described in terms of relative percentages. Thus, a ratio of 1:1 may also be described as 50:50. Further, the application ratio can be determined on a piecewise basis (i.e., with reference to a number of food pieces selected from each portion), calculated on a weight basis, or any other method.

Accordingly, in a first aspect of the invention, a savory food product is provided that is formed from a plurality of food pieces selected from one of two cooked portions. The first portion is salted at a first salt intensity and the second portion is salted at a second salt intensity that is different than the first. Subsequently mixing the first and second portions at a predetermined application ratio enables the creation of a savory food product that has a desired average salt concentration. Importantly, the average salt concentration of the product of the present invention imparts a saltiness that tastes saltier than a control sample having an equivalent salt intensity, but which is created using traditional means where every piece is equally and uniformly salted.

In a second aspect of the invention, a method is provided for creating a savory food product formed from a plurality of pieces by application of sodium contrast. This method generally includes the steps of cooking a plurality of food pieces, then salting a first portion of the plurality of cooked food pieces at a first salt intensity. A second portion of the plurality of cooked food pieces is salted at a second salt intensity. Thereafter, all or part of the first portion is mixed with all or part of the second portion at a predetermined application ratio to create the savory food product having a plurality of pieces with a desired average salt concentration. The average salt concentration that tastes saltier than a control sample having the same salt intensity, but created using traditional means where every piece is equally and uniformly salted.

In a third aspect of the invention, a system is provided for creating a savory food product formed from a plurality of pieces by application of sodium contrast. The system generally includes a cooking device that is upstream and in communication with a first tumbler and second tumbler in a substantially parallel configuration. The first tumbler imparts a first salt intensity to a first portion of the cooked food pieces exiting the cooking device. The second tumbler imparts a second salt intensity to a second portion of the cooked food pieces exiting the cooking device. All or a portion of each of the plurality of food pieces from the first and second tumblers are mixed at a predetermined application ratio by a mixing device downstream from the first and second tumbler. In first embodiment of this aspect of the invention, the mixing device is a third tumbler. In second embodiment of this aspect of the invention, the mixing device is a vibrating conveyor.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a bar graph presenting evidence in support of sodium contrast as applied to a savory food product formed from a plurality of food pieces.

FIG. 2 is a graph comparing the perceived saltiness of a control sample at a salt intensity of 0.9 weight percent with experimental samples having an average salt concentration of 0.9 weight percent, but with differing application amplitudes and application ratios.

FIG. 3 is a graph comparing the perceived saltiness of a control sample at a salt intensity 1.2 weight percent with experimental samples having an average salt concentration of 1.2 weight percent, but with differing application amplitudes and application ratios.

FIG. 4 is a graph comparing the perceived saltiness of a control sample at a salt intensity 1.5 weight percent with experimental samples having an average salt concentration of 1.5 weight percent, but with differing application amplitudes and application ratios.

FIGS. 5a and 5b are bar graphs supporting a 20% reduction of sodium content by implementation of sodium contrast. In particular, FIG. 5a shows a statistically significant number of tasters correctly identifying the saltier of two samples in the absence of sodium contrast. In FIG. 5b, due to sodium contrast, tasters perceived both samples as equally salty despite a 20% difference in salt content.

FIG. 6 is a system for creating a savory food product with reduced sodium content in accordance with an illustrative embodiment.

FIG. 7 is an alternate system for creating a savory food product with reduced sodium content in accordance with an illustrative embodiment.

FIG. 8 is a flowchart of process for creating a savory food product with reduced sodium content in accordance with an illustrative embodiment.

### DETAILED DESCRIPTION OF THE INVENTION

The present invention is thus directed to a savory food product having reduced sodium content. Additionally, a corresponding method and two illustrative systems are disclosed for creating the savory food product by implementing sodium contrast to achieve the sodium reduction. As already mentioned, sodium contrast is based on the observation that sensory receptors, including those that are used for tasting, are more sensitive to stimulus contrasts. Although sodium contrast has been demonstrated in products that could be formed from a dough-based product with layers having different sodium concentrations, such as bread, this principle was never before applied to a savory food product formed from a plurality of food pieces, such as a bag of potato chips, because individual pieces cannot be practically salted at two or more different sodium concentrations.

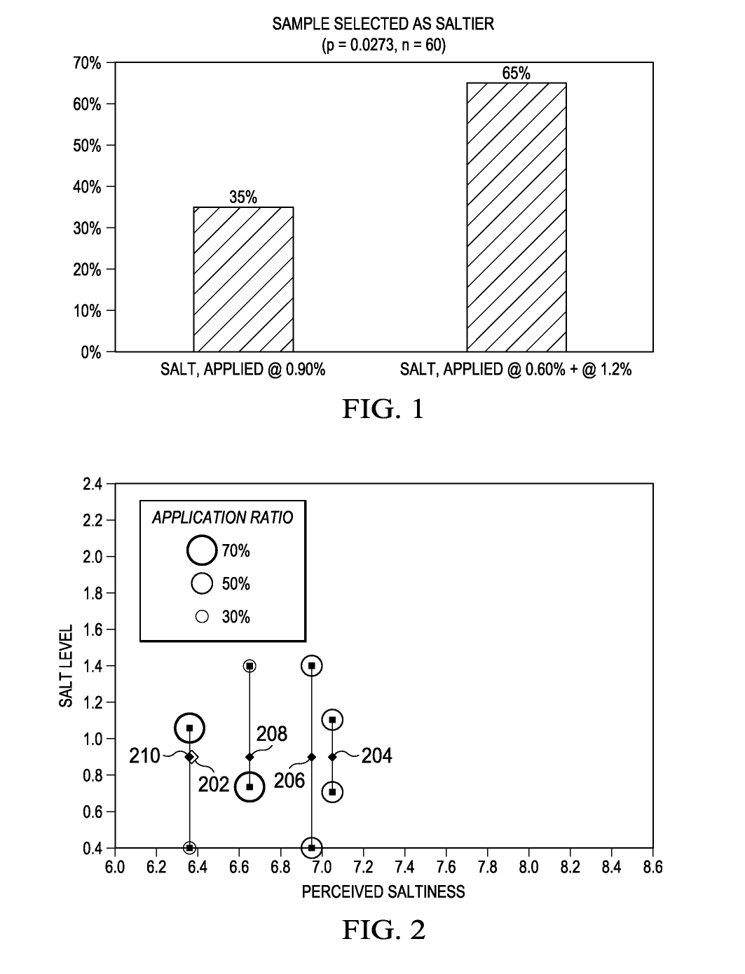

To test the theory of sodium contrast as applied to a savory food product formed from a plurality of pieces, Applicants devised a first experiment comparing the perceived saltiness of a control sample having a predetermined salt intensity with that of an experimental sample formed from a plurality of pieces selected from one of two different portions, each of which has a different salt intensity. Importantly, the experimental sample had an average salt concentration equal to the salt intensity of the control sample. The results of this experiment are depicted in FIG. 1.

FIG. 1 is a bar graph presenting evidence in support of sodium contrast as applied to a savory food product formed from a plurality of food pieces. The savory food product in this experiment was in the form of potato chips. A control sample was given a salt intensity of 0.90 weight percent. The experimental sample had an average salt concentration of 0.90 weight percent, but was formed from two portions having different salt intensities and an application amplitude of 0.30 weight percent. Specifically, the first portion had a salt intensity of 0.60 weight percent, and the second portion had a salt intensity of 1.20 weight percent. Because the first and second portions were mixed in a 1:1 ratio, the experimental sample had an average salt concentration of 0.90 weight percent. Moreover, because the control sample and the experimental sample were formed with an equal number of chips, each sample had the same sodium content. Tasters were asked to eat every piece of each sample and asked to identify the sample that tasted saltier. The results indicate that a statistically significant number of tasters identified the second sample as saltier despite the fact that both samples had the same sodium content and the same average salt concentration.

Having confirmed the viability of sodium contrast for a savory food product comprising a plurality of pieces, Applicants designed another experiment that tested the effect of application amplitude, application ratio, and average salt concentration on the perceived saltiness of the savory food product. Applicants utilized multivariate design testing and experimented with various application amplitudes that had application ranges between 0.4 weight percent and 1.0 weight percent; application ratios of 50:50, 30:70, and 70:30; and average salt concentrations of 0.90, 1.20, and 1.50 weight percent. For each of the trials embodied by FIGS. 2, 3, and 4, tasters were asked to compare a control sample with an experimental sample, both of which had an equal number of chips. Importantly, the salt intensity of the control sample was the same as the average salt concentration of the experimental samples; consequently, each sample also had the same sodium content. Tasters were asked to consume all the food pieces in each of the samples and asked to determine whether the control sample or the experimental sample tasted saltier.

FIG. 2 is a graph comparing the perceived saltiness of a control sample with a salt intensity of 0.90 weight percent with four experimental samples having an average salt concentration of 0.90 weight percent, but with differing application amplitudes and application ratios. Specifically, control sample 202 was compared with experimental samples 204, 206, 208, and 210.

Experimental sample 204 had an application ratio of 50:50 and an application amplitude of 0.20 weight percent. Thus, the application range was 0.40 weight percent. Experimental sample 206 also had an application ratio of 50:50, but had an application amplitude of 0.50 weight percent, which resulted in an application range of 1.0 weight percent. Experimental sample 208 had an application ratio of 30:70, an upper application amplitude of 0.50 weight percent, and a lower application amplitude of 0.20 weight percent. Accordingly, the application range was 0.70 weight percent. Experimental sample 210 had an application ratio of 70:30, an upper application amplitude of 0.20 weight percent, and a lower application amplitude of 0.50 weight percent. The application range for experimental sample 210 was also 0.70 weight percent.

Experimental samples 204 and 206 were identified as the saltiest samples. In contrast, experimental sample 210, which had a greater number of food pieces selected from the saltier portion, was judged to be no saltier than control sample 202. However, experimental sample 208, which had a greater number of food pieces selected from the less salty portion, tasted saltier than control sample 202 and experimental sample 210, but was perceived to be less salty than either of experimental samples 204 and 206.

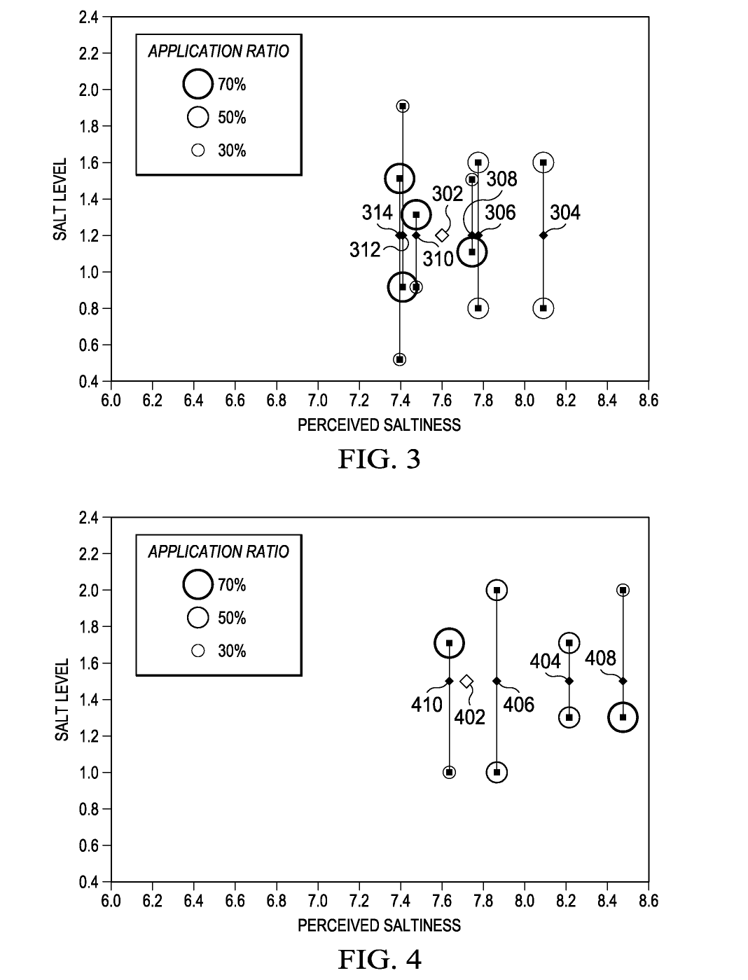

FIG. 3 is an is a graph comparing the perceived saltiness of a control sample with a salt intensity of 1.20 weight percent with six experimental samples having an average salt concentration of 1.20 weight percent, but with differing application amplitudes and application ratios.

Control sample 302 served as a baseline for comparison with experimental samples 304, 306, 308, 310, 312, and 314. Experimental samples 304 and 306 were both assigned an application ratio of 50:50 and an application amplitude of 0.40 weight percent. The corresponding application range was 0.80 weight percent. Experimental sample 308 had an application ratio of 30:70 and an upper application amplitude of 0.30 weight percent and a lower application amplitude of 0.10 weight percent for a total application range of 0.40 weight percent. Experimental sample 310 has an application ratio of 70:30, an upper application amplitude of 0.1 weight percent, and a lower application amplitude of 0.30 weight percent. The application range was 0.40 weight percent. Experimental sample 310 has an application ratio of 30:70 and an upper application amplitude of 0.70 weight percent and a lower application amplitude of 0.30 weight percent, and an application range of 1.0 weight percent. Experimental sample 312 has an application ratio of 70:30, an upper application amplitude of 0.30 weight percent, and a lower application amplitude of 0.70 weight percent. The corresponding application range was also 1.0 weight percent. Lastly, experimental sample 314 had an application ratio of 70:30, and upper application amplitude of 0.30 weight percent, a lower application amplitude of 0.70 weight percent, and an overall application range of 1.0 weight percent.

The results depicted in the graph of FIG. 3 show samples 310, 312, and 314 as being perceived as less salty then control sample 302. Notably, the experimental samples in FIG. 3 which had an application ratio of 70:30 (i.e., with a greater number of food pieces selected from the saltier portion) were perceived as less salty then the control sample 302. This result was consistent with the results of FIG. 2. Also consistent with the results of FIG. 2 was the fact that experimental samples 304 and 306, which had a 50:50 application ratio and equal application amplitudes, were perceived as being saltier than control sample 302 and saltier than the other experimental samples.

FIG. 3 shows that experimental sample 308, which had an application ratio of 30:70, was saltier than control sample 302 but less salty then experimental samples 304 and 306. This result was also consistent with the results of FIG. 2. Interestingly, experimental sample 312, which also had an application ratio of 30:70, was perceived as less salty then control sample 302. This result may be attributable to the fact that the application range of experimental sample 312 was 1.0 weight percent, whereas the application range of experimental sample 308 was 0.4 weight percent, which was less than half that of experimental sample 312.

FIG. 4 is a graph showing a comparison of the perceived saltiness of a control sample having a salt intensity of 1.5 weight percent with four experimental samples having an average salt concentration of 1.5 weight percent, but with differing application amplitudes and application ratios.

Control sample 402 served as a baseline for comparison with experimental samples 404, 406, 408, and 410. Experimental sample 404 had an application ratio of 50:50 and an application amplitude of 0.20 weight percent. The corresponding application range was calculated at 0.40 weight percent. Experimental sample 406 had an application ratio of 50:50, an application amplitude of 0.50 weight percent, and an application range of 1.0 weight percent. Experimental sample 408 had an application ratio of 30:70, and upper Application amplitude of 0.50 weight percent, and a lower application amplitude of 0.2 weight percent. The overall application range for sample 408 was equal to 0.70 weight percent. Lastly, experimental sample 410 had an application ratio of 70:30, and upper application amplitude of 0.20 weight percent, a lower application amplitude of 0.50 weight percent, and an application range of 0.70 weight percent.

The results depicted in FIG. 4 share similarities with the results shown in FIGS. 2 and 3 above. For example, the experimental samples with application ratios of 50:50 were perceived as saltier than the control sample, and experimental sample 410, which was formed from a greater number of food pieces selected from the saltier portion, was judged to be less salty than control sample 402. Finally, experimental sample 408, which was formed from a greater number of food pieces selected from the less salty portion, was perceived to be saltier than the control sample.

Based on the results above, Applicants have determined that a savory snack food product can be created using sodium contrast to increase the perceived saltiness without increasing the sodium content. Specifically, overall application range did not have a significant effect, and sodium contrast could be observed in experimental samples having the lowest application amplitude of 0.20 weight percent. Applicants believe that experimental samples formed with a greater number of pieces selected from a saltier portion were perceived as equally salty or less salty than respective control samples. Applicants believe that these results are likely due to the fact that the sodium taste receptors in the mouth may be nearing saturation, preventing the optimum realization of sodium contrast. Finally, the balanced mixes seemed to provide higher perceived saltiness, and effects of sodium contrast were perceived in experimental samples having average salt concentrations of 0.90 weight percent, 1.20 weight percent, and 1.50 weight percent.

Thus, in a first embodiment a savory food product can be created which has an average of salt concentration in the range of 0.5 weight percent to 1.4 weight percent. In a second embodiment, the savory food product has an average salt concentration in a more preferred range of 0.70 weight percent to 1.20 weight percent. In a third embodiment, the savory food product has an average salt concentration in a most preferred range of about 0.80 to 1.0 weight percent. In each of these three embodiments, application amplitudes should be at least about 20-30 percent.

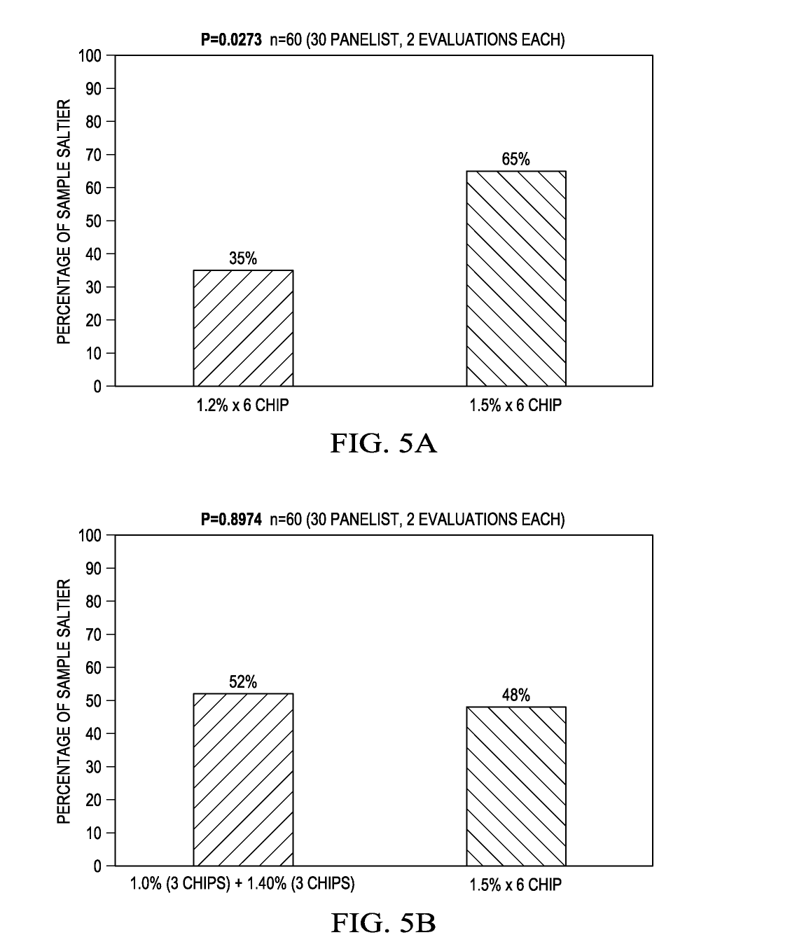

Having established that sodium contrast could be applied to a salty food product according to the criteria above, Applicants attempted to quantify an amount of sodium reduction that could be realized using sodium contrast without affecting the perceived saltiness of the savory food product. The results are depicted in FIGS. 5a and 5b.

FIGS. 5a and 5b are graphs illustrating a threshold amount of sodium reduction that can be achieved without any perceivable reduction of saltiness. In FIG. 5a Applicants compared a first sample having a salt intensity of 1.2 weight percent with a second sample having a salt intensity of 1.5 weight percent. The results indicated that a statistically significant number of tasters identified the second sample having the higher salt intensity as the saltier sample. In FIG. 5b, Applicants replaced the first sample with another sample having an average salt concentration of 1.2 weight percent, but which was formed from two portions having different salt intensities. Specifically, the first portion was provided with a salt intensity of 1.0 weight percent and the second portion was provided with a salt intensity of 1.40 weight percent. This sample was then compared with the second sample having a salt intensity of 1.5 weight percent. The results indicate that slightly greater than 50% of the tasters perceived that the first sample was saltier than the second sample despite the fact that the first sample had the sodium content that was 20% lower than the second sample. Thus, tasters believed that the two samples were perceived as equally salty despite the fact that the first sample had 20% less sodium than the second sample. Therefore, Applicants have shown that sodium contrast implemented in the manner described herein can achieve at least a 20% reduction sodium content.

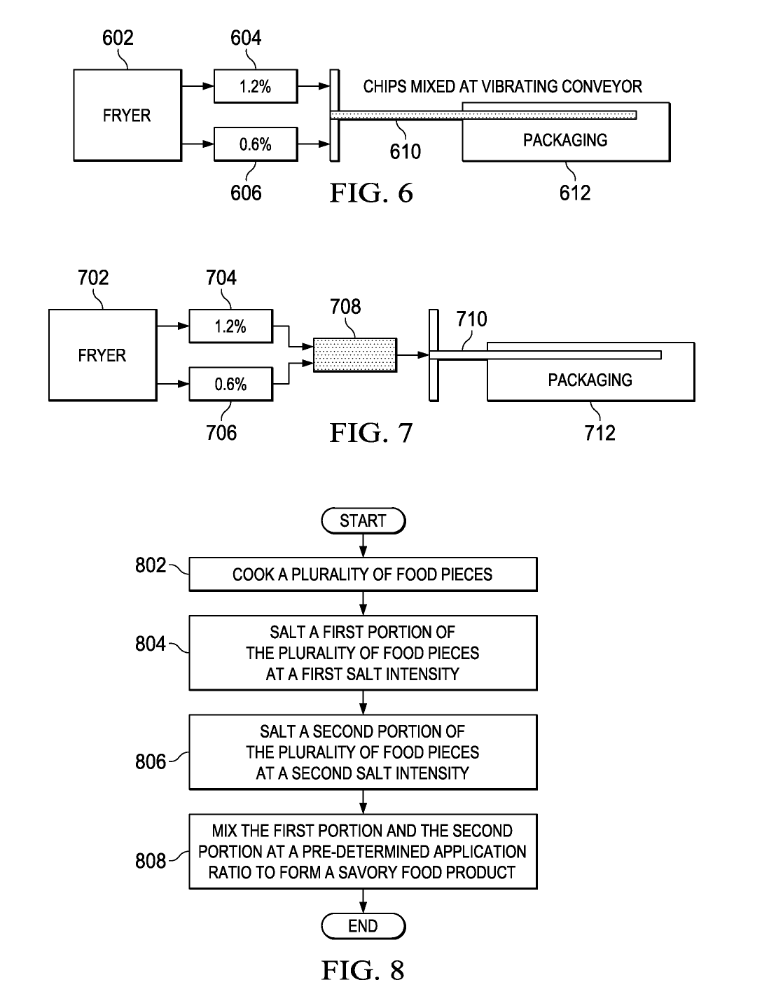

FIG. 6 is a system for creating a savory food product implementing sodium contrast in accordance with an illustrative embodiment. System 600 includes cooking device 602. Cooking device 602 may be any form of currently existing or later developed cooking device. In an illustrative embodiment where a savory food product is a potato chip, cooking device 602 may be a fryer or oven.

Cooking device 602 is upstream from and in communication with tumblers 604 and 606. Tumblers 604 and 606 are mixing devices for applying a salt intensity on a first and second portion of the cooked food pieces, respectively. In accordance with the example in FIG. 6, tumbler 604 is imparts a first salt intensity to a first portion of cooked food pieces exiting cooking device 602. Likewise, tumbler 606 imparts second salt intensity to a second portion of cooked food pieces exiting cooking device 602. The first and the second salt intensities are different and, when mixed at a selected application ratio, a specified average salt concentration can be achieved. The mixing occurs at a mixing device downstream from tumblers 604 and 606. In this non-limiting embodiment, the mixing device is vibrating conveyor 610. The mixed food pieces exiting vibrating conveyor 610 proceed to packaging 612 for final preparation before shipping.

FIG. 7 is an alternate system implementing sodium contrast in accordance with an illustrative embodiment. System 700 is substantially similar to system 600 with the exception of the third mixing device. Thus, cooking device 702, and tumblers 704 and 706 are components analogous to cooking device 602, and tumblers 604 and 606, respectively, in FIG. 6. Salted food pieces exiting tumblers 704 and 706 are mixed at a predetermined application ratio to achieve a specific average salt concentration. In this illustrative embodiment in FIG. 7, the mixing device is tumbler 708. Once thoroughly mixed, the savory food product is transported from tumbler 708 down conveyor 710 to packaging 712 for final preparations before shipment.

FIG. 8 is a flowchart for a process for creating a savory food product in accordance with an illustrative embodiment. The process depicted in FIG. 8 can be performed in a system for creating a savory food product, such as systems 600 or 700 in FIGS. 6 and 7, respectively.

The process begins by cooking a plurality of food pieces (step 802). The plurality of food pieces may be cooked in a cooking device such as cooking device 602. The process then salts a first portion of the plurality of food pieces at a first salt intensity (step 804). The salting step may be performed in a first tumbler, such as tumbler 604. A second portion of the plurality of food pieces is salted at a second salt intensity (step 806). The process then mixes all or part of the first portion with all or part of the second portion at a predetermined application ratio to form the savory food product (step 808). In a preferred embodiment, the predetermined application ratio is about 50:50.

The flowchart in the figure provided above illustrates a method for producing a savory food product formed from a plurality of pieces having a reduced sodium content. Each block in the flowchart may represent a step in an overall process. In some alternative implementations, the steps in the various blocks may occur out of order provided in the figures. For example, two blocks in a flowchart that are shown in succession may actually be implemented substantially concurrently. Alternatively, the steps depicted in two successive blocks may actually be executed in a reverse order, depending upon a particular implementation.

According to the system and method disclosed above, a savory food product formed from a plurality of pieces can be created with a reduced sodium content, but without any perceived decrease in saltiness. Manufacturers can satisfy consumer preferences for purchasing savory food products while delivering products having reduced sodium content. And at the same time, these products can be created with existing equipment that require little to no modification. Moreover, as compared with other sodium reduction techniques, the savory food product disclosed herein can be created with no increased costs in terms of repackaging, recipe formulations, and the like. Accordingly, the present invention discloses an unexpected improvement over the prior art because the amount of sodium applied to a food product can be reduced by at least 20% without altering the perceived saltiness of the savory food product. This sodium reduction strategy can be coupled with other sodium reduction strategies to synergistically reduce the levels of sodium present in topically seasoned food products.

While this invention has been particularly shown and described with reference to preferred embodiments, it will be understood by those skilled in the art that various changes in form and detail may be made therein without departing from the spirit and scope of the invention. The Applicants expect skilled artisans to employ such variations as appropriate, and the Applicants intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### ADDITIONAL DESCRIPTION

In a first aspect, the invention is a savory food product with reduced sodium content comprising a plurality of food pieces selected from a first portion and a second portion at a predetermined application ratio. The first portion is uniformly salted a first salt intensity and the second portion is uniformly salted at a second salt intensity that differs from the first.

Another embodiment including any one or more of the elements in a previous embodiment disclosed above wherein the predetermined application ratio is about 1:1.

Another embodiment including any one or more of the elements in a previous embodiment disclosed above wherein the savory food product comprises an average salt concentration calculated from the first salt intensity and the second salt intensity, and wherein the average salt concentration is in the range of about 0.5 to 1.5 weight percent.

Another embodiment including any one or more of the elements in a previous embodiment disclosed above, wherein the average salt concentration is a preferred range of 0.7 to 1.2 weight percent.

Another embodiment including any one or more of the elements in a previous embodiment disclosed above, wherein the average salt concentration is in a most preferred range of 0.8 to 1.0 weight percent.

Another embodiment including any one or more of the elements in previous embodiment disclosed above, wherein the first salt intensity and the second salt intensity comprise an application amplitude of at least 20%-30%.

Another embodiment including any one or more of the elements in a previous embodiment disclosed above, wherein the application amplitude is selected from one of 0.3 weight percent, 0.6 weight percent, and 0.8 weight percent.

Another embodiment including any one or more of the elements in a previous embodiment disclosed above, wherein the first salt intensity and the second salt intensity comprise an application range of at least 0.4 weight percent.

Another embodiment including any one or more of the elements in a previous embodiment disclosed above, wherein the first salt intensity and the second salt intensity comprise an application range of less than 1.0 weight percent.

Another embodiment including any one or more of the elements in a previous embodiment disclosed above, wherein an upper application amplitude is greater than a lower application amplitude.

Another embodiment including any one or more of the elements in a previous embodiment disclosed above, wherein the first salt intensity is greater than the second salt intensity, and wherein the application ratio of the first portion in relation to the second portion is 30:70.

Another embodiment including any one or more of the elements in a previous embodiment disclosed above, wherein the savory food product is one of potato chips, corn chips, bagel chips, multigrain chips, pretzels, and tortilla chips.

In a second aspect, the invention is a method for creating a savory food product with reduced sodium content, wherein the savory food product is formed from a plurality of pieces. The steps of the method generally include cooking the plurality of pieces, salting a first portion of the plurality of pieces at a first salt intensity, salting a second portion of the plurality of pieces at a second salt intensity that is different than the first, and then mixing the first portion and the second portion at a preselected application ratio to form the savory food product.

Another embodiment including any one or more of the elements in a previous embodiment disclosed above, wherein the preselected ratio is about 1:1.

Another embodiment including any one or more of the elements in a previous embodiment disclosed above, wherein the cooking step comprises frying.

In a third aspect, the invention is a system for creating a savory food product with reduced sodium content, wherein the savory food product is formed from a plurality of pieces. The system comprises a cooking apparatus for cooking a plurality of food pieces. The system also comprises a first tumbler downstream from the cooking apparatus which is configured for salting a first portion of the plurality of pieces at a first salt intensity. The system also includes a second tumbler downstream from the cooking apparatus which is configured for salting a second portion of the plurality of pieces at a second salt intensity that is different than the first. The system also includes a mixing device downstream from the first tumbler and the second tumbler, which is configured for mixing the first portion and the second portion at a preselected application ratio to form the savory food product.

Another embodiment including any one or more of the elements in a previous embodiment disclosed above, wherein the mixing device is selected from one of a vibrating conveyor or a third tumbler.

Another embodiment including any one or more of the elements in a previous embodiment disclosed above, wherein the preselected application ratio is about 1:1.

We claim:

1. A savory food product comprising:
a mixture of food pieces comprising a first portion of the food pieces and a second portion of the food pieces, wherein:
the first portion is salted at a first salt intensity;
the second portion is salted at a second salt intensity;
the first salt intensity differs from the second salt intensity; and
the first portion and the second portion are mixed at an application ratio.

2. The savory food product of claim 1, wherein the application ratio is about 1:1.

3. The savory food product of claim 1 further comprising:
an average salt concentration between about 0.5 and 1.5 weight percent.

4. The savory food product of claim 3, wherein the average salt concentration is between about 0.7 and 1.2 weight percent.

5. The savory food product of claim 3, wherein the average salt concentration is between about 0.8 and 1.0 weight percent.

6. The savory food product of claim 3, wherein the first salt intensity and the second salt intensity comprise an application amplitude of at least 20%.

7. The savory food product of claim 3, wherein the first salt intensity and the second salt intensity comprise an application amplitude between 0.3 weight percent and 0.8 weight percent.

8. The savory food product of claim 3, wherein the first salt intensity and the second salt intensity comprise an application range of at least 0.4 weight percent.

9. The savory food product of claim 3, wherein the first salt intensity and the second salt intensity comprise an application range of less than 1.0 weight percent.

10. The savory food product of claim 3, wherein an upper application amplitude is greater than a lower application amplitude.

11. The savory food product of claim 1, wherein the first salt intensity is greater than the second salt intensity, and wherein the application ratio of the first portion in relation to the second portion is 30:70.

12. The savory food product of claim 1, wherein the savory food product is one of potato chips, tortilla chips, corn chips, bagel chips, multigrain chips, pretzels, nuts, and seeds.

13. A method for creating a savory food product, the method comprising:
cooking a mixture of food pieces;
salting a first portion of the mixture of the food pieces at a first salt intensity;
salting a second portion of the mixture of food pieces at a second salt intensity that is different than the first salt intensity; and
mixing the first portion and the second portion at an application ratio to form the savory food product.

14. The method of claim 13, wherein the application ratio is about 1:1.

15. The method of claim 13, wherein the cooking step comprises frying.

16. A system for creating a savory food product with reduced sodium content, the system comprising:
a cooking apparatus for cooking a mixture of food pieces;
a first tumbler downstream from the cooking apparatus, wherein the first tumbler salts a first portion of the mixture of food pieces at a first salt intensity;
a second tumbler downstream from the cooking apparatus, wherein the second tumbler salts a second portion of the mixture of food pieces at a second salt intensity that is different than the first salt intensity; and
a mixing device downstream from the first tumbler and the second tumbler, wherein the mixing device mixes the first portion and the second portion at an application ratio to form the savory food product.

17. The system of claim 16, wherein the mixing device is selected from one of a vibrating conveyor or a third tumbler.

18. The system of claim 16, wherein the application ratio is about 1:1.
